(19) United States
(12) Patent Application Publication
(10) Pub. No.: US 2008/0264014 A1
(43) Pub. Date: Oct. 30, 2008

(54) Dust compressing apparatus of vacuum cleaner

(75) Inventors: Jang-keun Oh, Gwangju-City (KR); Il-du Jung, Gwangju-City (KR); Min-ha Kim, Gwangju-City (KR)

Correspondence Address: Paul D. Greeley;Ohlandt, Greeley, Ruggiero & Perle, L.L.P., 10th Floor, One Landmark Square, Stamford, CT, 06901-2682, US

(73) Assignee: Samsung Gwangju Electronics Co. Ltd.

(21) Appl. No.: 11/973,079

(22) Filed: Oct. 5, 2007

Related U.S. Application Data
(60) Provisional application No. 60/926,832, filed on Apr. 30, 2007.

(30) Foreign Application Priority Data
Jun. 18, 2007 (KR) 2007-59494

(51) Int. Cl. B01D 46/42; B01D 45/12

(52) U.S. Cl. 55/423; 55/429

(57) ABSTRACT

A dust compressing apparatus of a vacuum cleaner capable of automatically compressing dust or dirt collected in a dust separating unit is disclosed. The dust compressing apparatus includes a compressing plate to compress dust or dirt collected in a dust separating unit, a moving unit disposed on one side of the dust separating unit located in an opposite direction to a direction where the compressing plate compresses the dust or dirt, to move the compressing plate to a compressing position of compressing the dust or dirt and a releasing position of moving away from the dust or dirt, and a driving motor to drive the moving unit thus to move the compressing plate to the compressing position.

### CROSS-REFERENCE TO RELATED APPLICATIONS

This application claims the benefit under 35 U.S.C. § 119 of U.S. Provisional Patent Application No. 60/926,832, filed Apr. 30, 2007, in the United States Patent and Trademark Office, and Korean Patent Application No. 10-2007-0059494, filed on Jun. 18, 2007, in the Korean Intellectual Property Office, the entire contents of which are hereby incorporated by reference.

### BACKGROUND OF THE INVENTION

1. Field of the Invention

The present disclosure relates to a vacuum cleaner. More particularly, the present disclosure relates to a cyclone dust separating apparatus of a vacuum cleaner, which draws in external air and separates dust or dirt from the drawn-in air.

2. Description of the Related Art

In general, a cyclone dust separating apparatus provided in a vacuum cleaner is an apparatus, which whirls air laden with dirt or dust and separates the dirt or dust therefrom. Such a cyclone dust separating apparatus has been recently widely used because it can be semi-permanently used without any inconvenience of frequently replacing dust bags.

The cyclone dust separating apparatus usually has a cyclone structure, which includes a cyclone to make drawn-in air into a whirling current and thus to separate dust or dirt from the drawn-in air, an air inflow part to guide the drawn-in air to flow into the cyclone in a tangential direction thereof, and a dust bin to collect and store the separated dust or dirt therein. In the cyclone structure as described above, the dust or dirt is randomly accumulated in the dust bin by the whirling air in the cyclone when it is collected in the dust bin. Thus, the conventional cyclone dust separating apparatus presents a problem that the dust or dirt is apt to scatter along with the whirling air and to flow backward into the cyclone again and as a result, a dust-separating efficiency is deteriorated. In addition, since the dust or dirt is loosely accumulated in the dust bin, a time that the dust bin is filled with the dust or dirt is not only shortened, so that a user should frequently empty the dust or dirt from the dust bin, but also a problem may occur, in that when the dust bin is emptied, the dust or dirt loosely accumulated in the dust bin is scattered to contaminate the surroundings.

To address the problems as described above, a vacuum cleaner having a dust compressing apparatus, which compresses dust or dirt collected and stored in a dust bin, is disclosed in Korean Patent No. 10-606794. The dust compressing apparatus of the vacuum cleaner is provided with a compressing plate to compress dust or dirt in a dust bin, a plunger connected to the compressing plate, a solenoid unit to drive the plunger up and down, and a restoring member to restore the lowered plunger to an original position. Accordingly, if the solenoid unit is operated to move the plunger down, the compressing plate is lowered to compress the dust or dirt in the dust bin. However, the dust compressing apparatus as described above is configured, so that the plunger and the restoring member are disposed below the compressing plate while penetrating through the dust bin. Accordingly, to empty the dust bin, the plunger and the restoring member together with the dust bin should be disassembled. Thus, the above dust compressing apparatus is disadvantageous in that it is difficult to remove the dust or dirt compressed in the dust bin.

Also, another vacuum cleaner having a dust compressing apparatus, which compresses foreign substance collected and stored in a dust collection container, is disclosed in U.S. Patent Publication No. 2006/0123749. The dust compressing apparatus of the vacuum cleaner is provided with a pressing member kept in a handle, a compartment plate provided below a filter to divide an inner space of the dust collection container into a foreign substance separating compartment and a foreign substance storing compartment, a bar joined to one side of the compartment plate and capable of moving up and down in the filter to guide the movement of the compartment plate, and an elastic member disposed around the bar to provide a restoring force when the bar is moved downward. Accordingly, if the user pulls out the pressing member from the handle and then inserts the pressing member by pushing it into the bar, the bar is moved downward and thus the compartment plate joined to a lower end of the bar is also moved downward to compress the foreign substance in the dust collection container. However, the dust compressing apparatus as described above is disadvantageous in that to compress the foreign substance in the dust collection container, the user should manually pull out the pressing member from the handle and then insert the pressing member by pushing it into the bar.

### SUMMARY OF THE INVENTION

An aspect of the present disclosure is to address at least the above problems and/or disadvantages and to provide at least the advantages described below. Accordingly, an aspect of the present disclosure is to provide a dust compressing apparatus of a vacuum cleaner capable of automatically compressing dust or dirt collected in a dust separating unit and at the same time, easily dumping the dust or dirt collected in the dust separating unit.

In accordance with an aspect of the present disclosure, a dust compressing apparatus of a vacuum cleaner includes a compressing plate to compress dust or dirt collected in a dust separating unit, a moving unit disposed on one side of the dust separating unit, the one side is located in an opposite direction to a direction where the compressing plate compresses the dust or dirt, to move the compressing plate to a compressing position of compressing the dust or dirt and a releasing position of moving away from the dust or dirt, and a driving motor to drive the moving unit thus to move the compressing plate to the compressing position.

Here, the moving unit may include a cam lever connected to a driving axis of the driving motor, so that the cam lever is rotated by the driving axis to push the compressing plate, and an elastic member to elastically urge the compressing plate to locate to the releasing position. At this time, the elastic member may include at least one tension spring connected between the compressing plate and a main body of the dust separating apparatus to pull the compressing plate to move to the compressing position when the cam lever pushes the compressing plate and to move to the releasing position when the cam lever moves away from the compressing plate.

Alternatively, the moving unit may include a crank shaft connected to a driving axis of the driving moor, so that the crank shaft is rotated by the driving axis, and a connecting rod having both ends rotatably fixed to the crank shaft and the compressing plate, respectively.

The dust separating unit may include at least one cyclone, and a dust bin unit to collect and store the dust or dirt separated by the cyclone therein. At this time, the cyclone may include a cyclone body having an air inlet and an air outlet, a guide member disposed to one side of the cyclone body in the cyclone body to guide air flowed in through the air inlet, an outflow pipe disposed to the other side of the cyclone body to communicate with the air outlet, and a dust discharging opening formed to a portion of the other side of the cyclone body to face the dust bin unit. Also, the dust bin unit may include a dust bin disposed parallel to the cyclone body and having an end to communicate with the dust discharging opening. In this case, the compressing plate may be formed of a plate formed in a shape corresponding to a cross section of the dust bin to move in the dust bin. Also, the dust bin may have a dust bin cover disposed at an opposite end to the end, which communicates with the dust discharging opening, to open and close the dust bin.

The driving of the driving motor may be controlled by one of a change in load of the driving motor and limit switches disposed at the compressing position and the releasing position of the compressing plate.

### BRIEF DESCRIPTION OF THE DRAWING FIGURES

The above and other objects, features, and advantages of certain exemplary embodiments of the present disclosure will be more apparent from the following description taken in conjunction with the accompanying drawings, in which:

FIG. 1 is a partially cut-away perspective view exemplifying a cyclone dust separating apparatus of a vacuum cleaner to which a dust compressing apparatus according to an exemplary embodiment of the present disclosure is applied;

FIG. 2 is a partial perspective view exemplifying an operation of a cam lever of the dust compressing apparatus of the cyclone dust separating apparatus illustrated in FIG. 1;

FIGS. 3A and 3B are cross-sectional views exemplifying an operation of the dust compressing apparatus of the cyclone dust separating apparatus illustrated in FIG. 1;

FIG. 4 is a partial cross-sectional view exemplifying a dust compressing apparatus according to another exemplary embodiment of the present disclosure;

FIGS. 5A and 5B are a side elevation and a front view exemplifying a moving unit of the dust compressing apparatus illustrated in FIG. 4; and

FIGS. 6A and 6B are cross-sectional views exemplifying an operation of the dust compressing apparatus illustrated in FIG. 4.

Throughout the drawings, the same reference numerals will be understood to refer to the same elements, features, and structures.

### DETAILED DESCRIPTION OF THE EXEMPLARY EMBODIMENTS

Hereinafter, a dust compressing apparatus of a vacuum cleaner according to exemplary embodiments of the present disclosure will be described in detail with reference to the accompanying drawing figures.

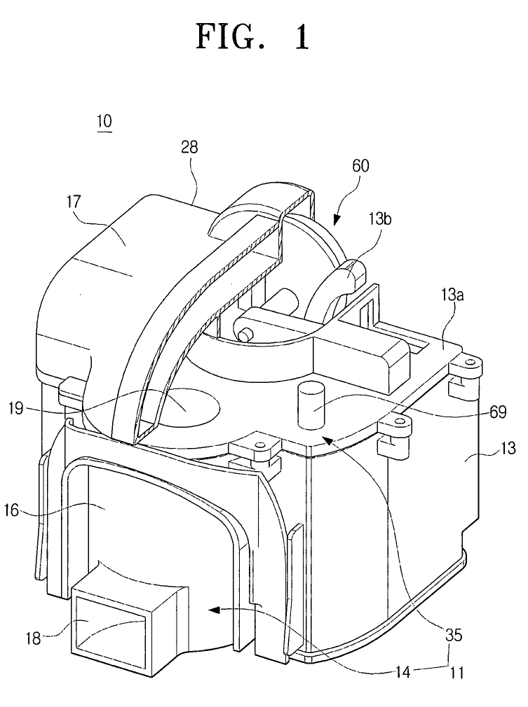

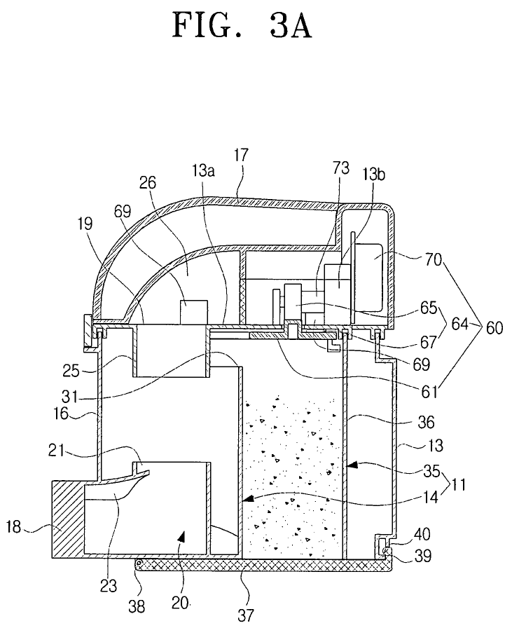

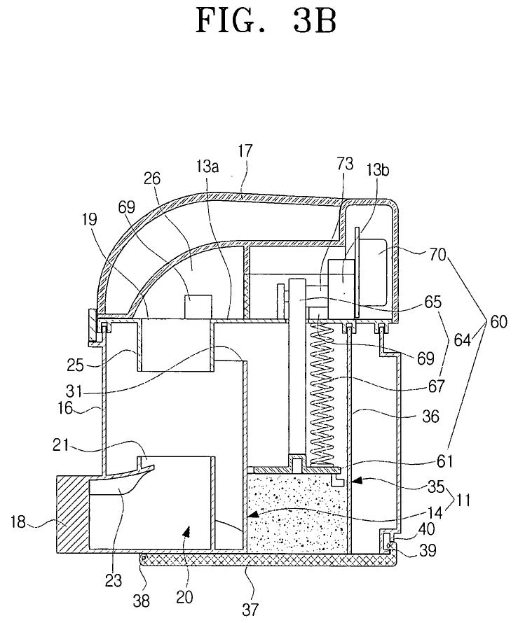

FIGS. 1, 3A and 3B are a partially cut-away perspective view and cross-sectional views exemplifying a cyclone dust separating apparatus of a vacuum cleaner to which a dust compressing apparatus according to an exemplary embodiment of the present disclosure is applied.

Referring to FIGS. 1, 3A and 3B, the cyclone dust separating apparatus 10 of the vacuum cleaner of the present disclosure includes a dust separating unit 11 to separate and collect dust or dirt from air by using a suction force of a suction motor (not illustrated) of the vacuum cleaner, and a dust compressing apparatus 60 according to the exemplary embodiment of the present disclosure to compress the dust or dirt collected in the dust separating unit 11.

The dust separating unit 11 is provided with a cyclone 14 and a dust bin unit 35.

The cyclone 14 centrifugally separates dust or dirt out of the air drawn in from the outside by the suction force of the suction motor. For this, the cyclone 14 is provided with a cyclone body 16 disposed at one side of a main body 13 in such a manner that a longitudinal axis thereof is vertically arranged. The cyclone body 16 is formed in a cylinder shape having an air inlet 18 and an air outlet 19 formed in one side of a lower end and the middle of an upper end thereof, respectively. At this time, the upper end of the cyclone body 16 is defined by an intermediate wall 13a of the main body 13. To guide the air drawn into the cyclone body 16 through the air inlet 18, a guide member 20 is disposed on the part of the lower end of the cyclone body 16. The guide member 20 is provided with a guide pipe 21 and a spiral blade 23, so that it guides the air drawn into the cyclone body 16 to whirl in a spiral shape. An outflow pipe 25 is disposed in the air outlet 19 formed on the part of the upper end of the cyclone body 16. The outflow pipe 25 guides the air whirling in the spiral shape by means of the guide member 20 in the cyclone body 16 to rotate in a spiral shape and at the same time, to discharge through the air outlet 19.

The air outlet 19 is communicated with an air discharging passage 26 of an upper cover 17. The upper cover 17 is provided with an air discharging opening 28 (see FIG. 1), which is directly or indirectly connected with the suction motor of the vacuum cleaner. A filter (not illustrated) can be installed in the air discharging passage 26 of the upper cover 17 to filter minute dust or dirt, which is not separated from the air by the cyclone 14. At this time, the filter may be formed of a sponge type filter, a high efficiency particulate arrestor (HEPA) filter, or a combination thereof.

A dust discharging opening 31 is formed in one side of an upper part of the cyclone body 16. The dust discharging opening 31 is communicated with a dust bin 36 of the dust bin unit 35, which will be described, so that it discharges the dirt or dust separated from the air by the cyclone 14, into the dust bin 36.

The dust bin unit 35 collects and stores the dust or dirt discharged through the dust discharging opening 31. The dust bin unit 35 includes a dust bin 36, which is disposed parallel to the cleaner body 16 and vertically in the main body 13. The dust bin 36 is formed in an approximately hexahedral tube shape, which surround the cyclone body 16. The dust bin 36 at an upper end thereof is defined by the intermediate wall 13a and at one lower side of the upper end thereof is opened to communicate with the dust discharging opening 31. On a lower part of the dust bin 36 is disposed a dust bin cover 37 to open and close the dust bin 36. Thus, the dust bin 36 can dump the dust or dirt collected therein. The dust bin cover 37 at one end thereof is hinged to a hinge axis 38 on an undersurface of the main body 13 and at the other end thereof has a hook 40 locked in a hooking groove 39 formed in a lower part of the main body 13. Accordingly, the dust bin cover 37 is pivoted on the hinge axis 38, so that the hook 40 can be locked in or released from the hooking groove 39. Thus, the dust bin cover 37 can open or close up the lower part of the dust bin 36.

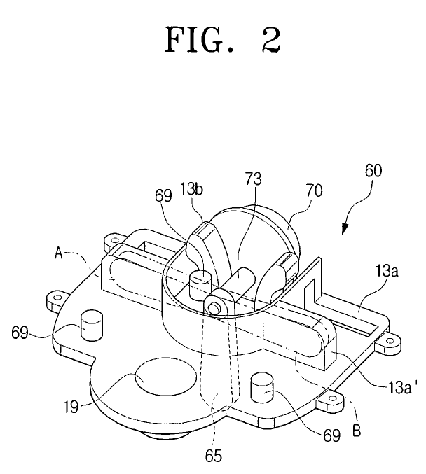

Referring to FIGS. 2, 3A and 3B, the dust compressing apparatus 60 is disposed on an upper part of the dust bin 36. The dust compressing apparatus 60 is provided with a compressing plate 61, a moving unit 64, and a driving motor 70.

The compressing plate 61, which compresses the dust or dirt collected in the dust bin 36, is made of a plate formed in a shape corresponding to a cross section of the dust bin 36 to move up and down in the dust bin 36.

The moving unit 64 is disposed above the dust bin 36. The moving unit 64 moves the compressing plate 61 to a compressing position (see FIG. 3B) where it compresses the dust or dirt and a releasing position (see FIG. 3A) where it is moved away from the dust or dirt. For this, the moving unit 64 is provided with a cam lever 65, and an elastic member 67. The cam lever 65 is connected to a driving axis 73 of the driving motor 70. The cam lever 65 is rotated by the driving axis 73 to push the compressing plate 61 to a first position (a solid line of FIG. 2) where it moves the compressing plate 61 to the compressing position or a second position (a dotted line A or B of FIG. 2) where it moves the compressing plate 61 to the releasing position.

The elastic member 67 is made up of at least one, for example, three tension springs, one ends of which are fixedly disposed in at least one, for example, three spring-accommodating parts 69 and other ends of which are fixed on upper surface of the compressing plate 61, respectively. The three spring-accommodating parts 69 are projected in a spaced-apart relation to one another in an upward direction from the intermediate wall 13a of the main body 13. The elastic member 67 elastically pulls the compressing plate 61 to maintain to the releasing position (see FIG. 3A).

Accordingly, as illustrated in FIG. 3B, when the cam lever 65 is rotated to the first position (the solid line of FIG. 2) by the driving axis 73 to push the compressing plate 61, the compressing plate 61 moves to the compressing position against an elastic force of the elastic member 67. To the contrary, as illustrated in FIG. 3A, when the cam lever 65 is rotated to the second position (the dotted line A or B of FIG. 2) by the driving axis 73 to move away from the compressing plate 61, the compressing plate 61 moves to the releasing position due to the elastic force of the elastic member 67.

The driving motor 70, which drives the moving unit 64 to move the compressing plate 61 to the compressing position, is installed on a fixing bracket 13b of the main body 13. The driving motor 70 is provided with a driving axis 73 having the cam lever 65 fixed on a front end thereof.

The rotation of the driving motor 70 can be controlled by a control unit (not illustrated). That is, when the cam lever 65 comes in contact with the compressing plate 61 or a lever cover 13a′ (see FIG. 2) of the intermediate wall 13a by the rotation of the driving axis 73, the driving motor 70 suffers a maximum load or an overload. At this time, the control unit detects a change of current according to a change of load through corresponding circuits, so that it senses the maximum load or the overload of the driving motor 70 and drives the driving motor 70 in a reverse direction or stops driving the driving motor 70. Alternatively, the rotation of the driving motor 70 can be controlled by limit switches (not illustrated) disposed in the dust bin 36 to detect the compressing position and the releasing position of the compressing plate 61.

In the above description, although the cyclone dust separating apparatus 10 to which the dust compressing apparatus according to the exemplary embodiment of the present disclosure is applied is illustrated and explained as having the cyclone body 16 of the cyclone 14 and the dust bin 36 of the dust bin unit 35 disposed in such a manner that the longitudinal axes thereof are vertically arranged, the present disclosure is not limited thereto. For instance, the dust compressing apparatus 60 according to the exemplary embodiment of the present disclosure is applicable to a cyclone dust separating apparatus having a cyclone body 16 and a dust bin 36 disposed in such a manner that longitudinal axes thereof are horizontally arranged, in the same construction and principle.

As described above, the cyclone dust separating apparatus 10 of the present disclosure is configured, so that the dust compressing apparatus 60 automatically ascends or descends the compressing plate 61 through the elastic member 67 and the cam lever 65, which is operated by the driving motor 70, thereby allowing the compressing plate 61 to compress the dust or dirt collected and stored in the dust bin 36. Accordingly, the problem that to compress the dust or dirt, the user should manually compress the compressing plate 61 through the pressing member as in the conventional apparatus can be addressed. Also, the cyclone dust separating apparatus 10 of the present disclosure is configured, so that the cam lever 65 and the elastic member 67 of the dust compressing apparatus 60 are located above the compressing plate 61 on the upper part of the dust bin 36 and the dust bin cover 37 is located on the lower part of the dust bin 36. Accordingly, to dump the dust or dirt compressed in the dust bin 36, there is no need of disassembling the dust compressing apparatus 60. Thus, the cyclone dust separating apparatus 10 of the present disclosure is advantageous in that it is easy to empty the dust or dirt from the dust bin 36.

Hereinafter, an operation of the cyclone dust separating apparatus 10 to which the dust compressing apparatus according to the exemplary embodiment of the present disclosure is applied, constructed as described above, will be now explained in detail with reference to FIGS. 1 through 3B.

First, the compressing plate 61 of the dust compressing apparatus 60 at an early state thereof is positioned in a releasing position illustrated in FIG. 3A. At this time, the cam lever 65 is located in a second position (a dotted line A or B (A in the present embodiment) of FIG. 2).

In this state, if the vacuum cleaner is supplied with the power, air laden with dust or dirt adhered to a surface to be cleaned is drawn into the cyclone body 16 through the air inlet 18 by an suction force of the suction motor directly or indirectly connected to the air discharging opening 28 of the upper cover 17. The drawn-in air forms a whirling current through the guide member 20 and the outflow pipe 25. As a result, the dust or dirt included in the drawn-in air is discharged into the dust bin 36 through the dust discharging opening 31 due to the centrifugal force, and collected and stored in the dust bin 36. And, the dust-removed air passes through the outflow pipe 25 and discharges to a cleaner body (not illustrated) in which the suction motor is installed, through the air discharging passage 26 and the air discharging opening 28 of the upper cover 17.

After the cleaning operation is completed as described above, if the user wants to compress the dust or dirt collected and stored in the dust bin 36 with the compressing plate 61, she or he pushes down a compression-executing button (not illustrated) of an operating panel (not illustrated) of the vacuum cleaner. According to this, the control unit drives the driving motor 70 in one direction, for example, a clockwise direction. Here, instead of driving the driving motor 70 when the user pushes down the compression-executing button, the control unit can be set to automatically drive the driving motor 70 when a dust detecting sensor (not illustrated) having a light emitting part and a light receiving part installed at a certain height in the dust bin 36 is operated.

As the driving motor 70 is driven in the clockwise direction, the cam lever 65 installed on the driving axis 73 is also rotated in the clockwise direction (a counterclockwise direction of FIG. 2) to push the compressing plate 61. As a result, the compressing plate 61 is lowered to a compressing position (see FIG. 3B) against an elastic force of the elastic member 67, so that it compresses the dust or dirt collected and stored in the dust bin 36.

As illustrated in FIG. 3B, when the compressing plate 61 almost compresses the dust or dirt in the dust bin 36, the driving motor 70 suffers a maximum load. At this time, the control unit detects a change of current according to a change of load through the corresponding circuits, so that it drives the driving motor 70 in a reverse direction, that is, a counterclockwise direction.

When the driving motor 70 is rotated in the counterclockwise direction, the cam lever 65 comes in contact with the lever cover 13a′ by the rotation of the driving axis 73. As a result, the driving motor 70 suffers an overload. At this time, the control unit detects the change of current according to the change of load, so that it stops driving the driving motor 70. Thus, the dust compressing operation of the dust compressing apparatus 60 is completed.

After the dust compressing operation is completed as described above, if the user wants to dump the dust or dirt compressed in the dust bin 36, she or he releases the hook 40 of the dust bin cover 37 from the hooking groove 39, opens the lower part of the dust bin 36 by pivoting the dust bin cover 37 on the hinge axis 38, and then removes the dust or dirt from the dust bin 36. And then, the user operates the dust bin cover 37 in a reverse order to an order of opening the dust bin 36 so as to close up the dust bin 36.

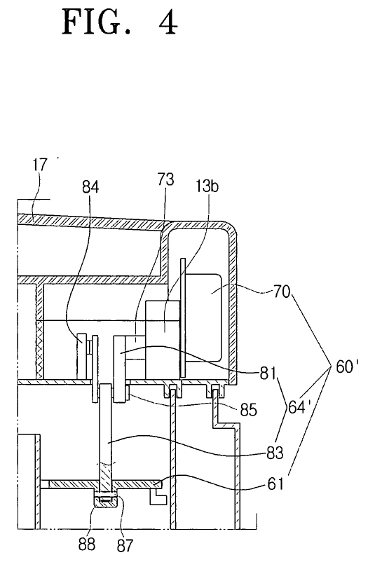

FIG. 4 exemplifies a dust compressing apparatus 60′ according to another exemplary embodiment of the present disclosure.

The dust compressing apparatus 60′ according to another exemplary embodiment is disposed on an upper part of the dust bin 36. The dust compressing apparatus 60′ is provided with a compressing plate 61, a moving unit 64′, and a driving motor 70. Since constructions of the compressing plate 61 and the driving motor 70 are the same as those of the dust compressing apparatus 60 explained with reference to FIGS. 1 through 3B, a detailed description thereof will be omitted.

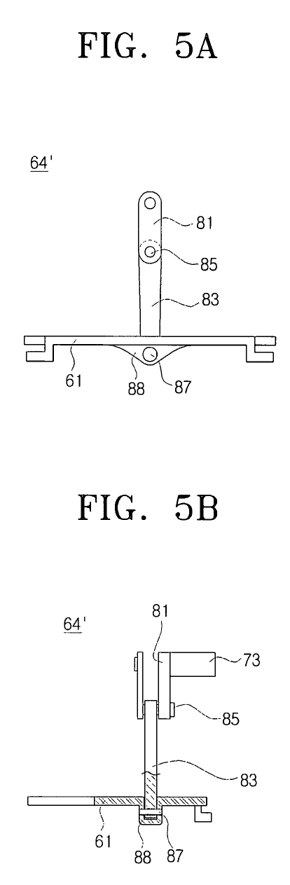

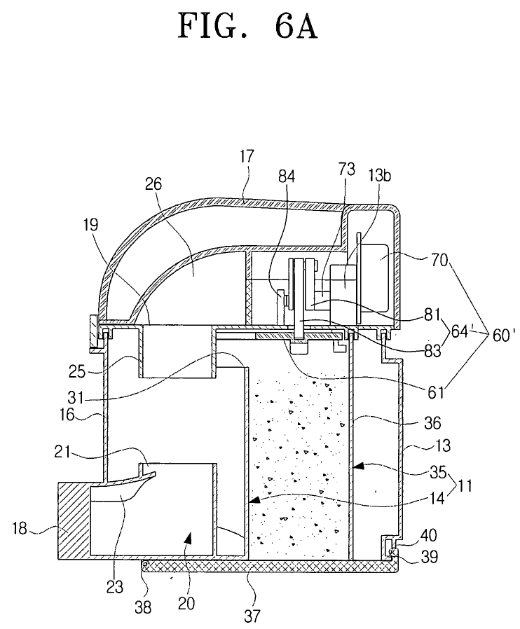

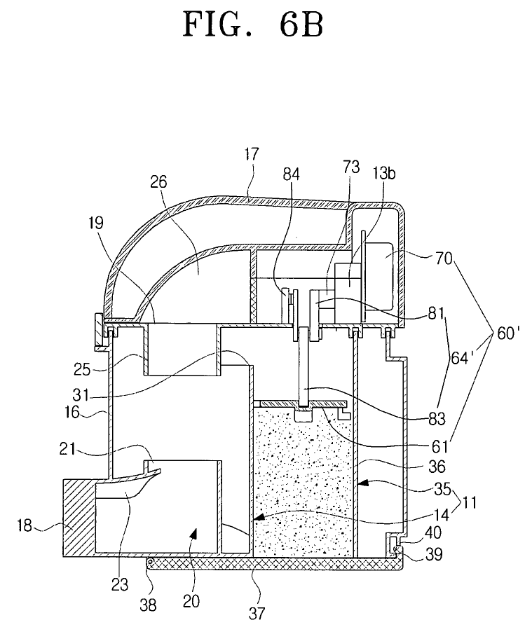

The moving unit 64′, which moves the compressing plate 61 to a compressing position (see FIG. 6B) where it compresses the dust or dirt and a releasing position (see FIG. 6A) where it is moved away from the dust or dirt, is disposed above the compressing plate 61. As illustrated in FIGS. 4, 5A and 5B, the moving unit 64′ is provided with a crank shaft 81 and a connecting rod 83. The crank shaft 81 at one end thereof is fixed on the driving axis 73 of the driving motor 70 and at the other end thereof is rotatably supported on a supporting bracket 84, so that it can be rotated by the driving axis 73 of the driving motor 70. The connecting rod 83 at both ends thereof is rotatably fixed on a crank pin 85 of the crank shaft 81 and a hinge axis 87 of a fixing groove part 88 of the compressing plate 61, respectively.

Accordingly, as illustrated in FIG. 6B, when the crank shaft 81 is rotated by the driving axis 73 to locate to a position where the crank pin 85 is most lowered, the compressing plate 61 is lowered by the connecting rod 83 to move to the compressing position. To the contrary, as illustrated in FIG. 6A, when the crank shaft 81 is rotated by the driving axis 73 to locate to a position where the crank pin 85 is most lifted, the compressing plate 61 is lifted by the connecting rod 83 to move to the releasing position. At this time, a change in load of the driving motor 70 according to the rotation of the crank shaft 81 is not large. Thus, preferably, but not necessarily, the rotation of the driving motor 70 is controlled by limit switches (not illustrated) disposed in the dust bin 36 to detect the compressing position and the releasing position of the compressing plate 61, instead of a method of detecting the load of the driving motor 70.

A dust compressing operation of the dust compressing apparatus 60′ constructed as described above is the same as that of the dust compressing apparatus 60 explained with reference to FIGS. 1 through 3B. Therefore, a detailed description of the dust compressing operation of the dust compressing apparatus 60′ will be omitted.

As apparent from the foregoing description, according to the exemplary embodiment of the present disclosure, the cyclone dust separating apparatus is configured, so that the dust compressing apparatus automatically ascends or descends the compressing plate through the elastic member or the connecting rod and the cam lever or the crank shaft, which is operated by the driving motor, thereby allowing the compressing plate to compress the dust or dirt collected and stored in the dust bin. Accordingly, the problem that to compress the dust or dirt, the user should manually compress the compressing plate through the pressing member as in the conventional apparatus can be addressed.

Also, according to the exemplary embodiment of the present disclosure, the cyclone dust separating apparatus is configured, so that the cam lever and the elastic member or the crank shaft and the connecting rod of the dust compressing apparatus are located above the compressing plate on one side, that is, the upper part of the dust bin and the dust bin cover is located on the other side, that is, the lower part of the dust bin. Accordingly, there is no need to disassemble the dust compressing apparatus to dump the dust or dirt compressed in the dust bin. Thus, the cyclone dust separating apparatus of the present disclosure is advantageous in that it is easy to empty the dust or dirt from the dust bin.

Although representative exemplary embodiments of the present disclosure have been shown and described in order to exemplify the principle of the present disclosure, the present disclosure is not limited to the specific embodiments. It will be understood that various modifications and changes can be made by one skilled in the art without departing from the spirit and scope of the disclosure as defined by the appended claims. Therefore, it shall be considered that such modifications, changes and equivalents thereof are all included within the scope of the present disclosure.

What is claimed is:

1. A dust compressing apparatus of a vacuum cleaner, comprising:
a compressing plate to compress dust or dirt collected in a dust separating unit;
a moving unit disposed on one side of the dust separating unit, the one side being located in an opposite direction to a direction where the compressing plate compresses the dust or dirt, the moving unit being configured to move the compressing plate to a compressing position to compress the dust or dirt and a releasing position to move away from the dust or dirt; and
a driving motor to drive the moving unit to move the compressing plate to the compressing position.

2. The dust compressing apparatus as claimed in claim 1, wherein the moving unit comprises:
a cam lever connected to a driving axis of the driving motor, so that the cam lever is configured to rotate by the driving axis to push the compressing plate; and
an elastic member to elastically urge the compressing plate to the releasing position.

3. The dust compressing apparatus as claimed in claim 2, wherein the elastic member comprises at least one tension spring connected between the compressing plate and a main body of a dust separating apparatus to pull the compressing plate to move to the compressing position when the cam lever pushes the compressing plate and to move to the releasing position when the cam lever moves away from the compressing plate.

4. The dust compressing apparatus as claimed in claim 1, wherein the moving unit comprises:
a crank shaft connected to a driving axis of the driving motor, so that the crank shaft is configured to rotate by the driving axis; and
a connecting rod having a first end rotatably fixed to the crank shaft and a second end rotatably fixed to the compressing plate.

5. The dust compressing apparatus as claimed in claim 1, wherein the dust separating unit comprises:
at least one cyclone; and
a dust bin unit to collect and store dust or dirt separated by the cyclone therein.

6. The dust compressing apparatus as claimed in claim 5, wherein the cyclone comprises:
a cyclone body having an air inlet and an air outlet;
a guide member disposed to one side of the cyclone body and in the cyclone body to guide air flowed in through the air inlet;
an outflow pipe disposed to an other side of the cyclone body to communicate with the air outlet; and
a dust discharging opening formed to a portion of the other side of the cyclone body to face the dust bin unit.

7. The dust compressing apparatus as claimed in claim 6, wherein the dust bin unit comprises a dust bin disposed parallel to the cyclone body and having an end to communicate with the dust discharging opening.

8. The dust compressing apparatus as claimed in claim 7, wherein the compressing plate comprises a plate formed in a shape corresponding to a cross section of the dust bin to move in the dust bin.

9. The dust compressing apparatus as claimed in claim 7, wherein the dust bin further comprises a dust bin cover disposed at an opposite end to the end, which communicates with the dust discharging opening, to open and close the dust bin.

10. The dust compressing apparatus as claimed in claim 1, wherein driving of the driving motor is controlled by a change in load of the driving motor or limit switches disposed at the compressing position and the releasing position of the compressing plate.
